(19) United States
(12) Patent Application Publication
(10) Pub. No.: US 2026/0259123 A1
(43) Pub. Date: Sep. 3, 2026

(54) SYSTEMS, DEVICES, AND METHODS FOR RHEOLOGICAL MEASUREMENT OF GRANULAR MEDIA

(71) Applicant: Massachusetts Institute of Technology, Cambridge, MA (US)

(72) Inventors: Robert C. MOOSE, Cambridge, MA (US); Crystal Elaine OWENS, Cambridge, MA (US); Gareth H. MCKINLEY, Cambridge, MA (US)

(21) Appl. No.: 18/994,440

(22) PCT Filed: Aug. 4, 2023
(86) PCT No.: PCT/US2023/071745

§ 371 Date: Jan. 14, 2025

Related U.S. Application Data
(60) Provisional application No. 63/370,378, filed on Aug. 4, 2022.

(51) Int. Cl. G01N 11/04

(52) U.S. Cl. CPC G01N 11/04

(57) ABSTRACT

The present disclosure is directed to system, devices, and methods for making rheological measurements of granular media, such as powders, in both the quasistatic and transitional regimes. A rheometer includes a material engagement device attached to a rotating device and placed in a cup that contains powder to be analyzed. The material engagement device can include a plurality of inclined blades connected to a central spindle. Each blade can include a top surface having an initial angle of elevation with respect to a plane perpendicular to the axis of rotation of the spindle to form a helicoid. The helix angle can be varied from 10° to 35° and blade count from two to six to assess rheological measurement data.

### CROSS REFERENCE TO RELATED APPLICATION

The present disclosure claims priority to U.S. Provisional Application No. 63/370,378, entitled “Systems, Devices, and Methods for Rheological Measurement of Granular Media,” which was filed on Aug. 4, 2022, and which is incorporated by reference herein in its entirety.

### FIELD

The present disclosure relates to systems, devices, and methods for rheological measurements of granular media, and more particularly relates to rheometric fixtures that include a material engagement device attached to a rotating device and placed in a cup that contains granular media, such as powder, to be analyzed.

### BACKGROUND

Rheology is the study of deformation and flow of materials that can be applied generally to solids and fluids (liquids and gases), but for solids relates to conditions in which they respond with plastic or viscous flow, rather than purely elastic deformation, in response to an applied force. The rheology of a material describes its viscosity as a function of shear rate, temperature, concentration, and other factors. This measurement allows for quantitatively predicting material behavior in a wide variety of processes, including mixing, pumping, squirting, and scooping, and is also useful for quality control. Materials such as yield stress fluids are those that have a critical stress above which it flows like a viscoplastic liquid, and below which it deforms as a viscoelastic solid. Common yield stress fluids can include emulsions, foams, particulate suspensions, and granular materials, in which particles, bubbles, emulsions, and/or other microparticle constituents interact via weak physico-chemical forces and geometric packing/jamming constraints. As the imposed stress acting on these soft solids increases, complex time-dependent rheological signatures arise from underlying microstructural processes such as shear-induced break-down and restructuring. Additionally, other effects can arise, such as time-dependent aging and onset of non-homogeneous flow, resulting in common rheological signatures, including a strong influence of the history of deformation, hysteresis, thixotropy, shear-banding, and/or slip of the material on the surface of the tool used for rheological measurements. As a result, sensitivity to loading conditions, ensuring kinematic homogeneity, and unambiguous control of history of deformation each pose challenges for rheological measurements of yield stress fluids.

A rheometer is a machine used to measure rheological properties of a material, namely properties that describe how the material flows or deforms in response to applied forces. There are several types of rheometers. For example, a shear rheometer can measure shear and can be a native strain-controlled instrument (which controls and applies a user-defined shear strain, and then measures the resulting shear stress) or a native stress-controlled instrument (which controls and applies a user-defined shear stress and then measures the resulting shear strain). These rheometers can also often control axial position and/or can measure axial force as well.

Powders and other granular media are used in a variety of industries, including pharmaceutical and medication manufacture, three-dimensional (3D) printing of plastics and metals, food production, construction, and more. A granular medium can include a collection of discrete rigid particles in solid contact with each other with a gas (rather than a liquid) as the main continuous fluid medium. A granular medium may be non-cohesive or cohesive, and typically does not resist tensile stresses. A powder is a kind of granular medium in which the particles are small, such as having diameters less than about 100 μm and more than about 1 μm. Other examples of granular media include sand, diatomaceous earth, fertilizer, soil, snow, and ball bearings. The discrete particles may be spherical or non-spherical, rigid or deformable, and may vary in size. The granular medium is usually not perfectly dry, and may have a small amount of humidity, or more liquid such that the particles interact with each other by capillary bridges, though substantial gas still perfuses the system.

While the quasistatic behaviors of these materials is well studied, understanding of the flow characteristics of these materials remains limited. As such, improved determination of their rheological properties is highly valuable to improving manufacturing throughput and costs. A great variety of tools exist to measure these well-studied quasistatic properties, but rather few are available to characterize the bulk friction coefficient at high deformation rates. For example, the Brookfield Power Flow Tester, Jenike Powder Tester, Salerno Unconfined Compression Tester, Edinburgh Powder Tester, Environmental Caking Tester, and the shear cell of the FT4 Powder Rheometer are examples of tools that can be used to measure quasistatic behaviors. All of these instruments characterize bulk powder failure for flow initialization, but there are rather few instruments available to capture behavior at high strain rates in the dynamic regime. Chief among these high shear rate tools is the FT4 Powder Rheometer. Specifically, the FT4 Powder Rheometer may be capable of measuring the flow properties of powders but needs much additional investigation into flow mechanics to relate tool output parameters to frictional rheology characteristics. The FT4 Rheometer can include a tall cylindrical vessel that contains the powder bed, and an impeller that rotates while traveling upward or downward through the powder bed. The FT4 impeller varies in pitch as the radius increases from the central axle, which imposes a wide range of shear rates and shear stresses on the powder as the tool travels through the bed. As a result, measurements from the FT4 Rheometer can be limited to the work expended by the impeller, and cannot easily be extrapolated to measurements of a full rheological powder flow curve (μ of I curve). Instead, several works have performed simulations to determine flow properties at various regions in the bed at and around the impeller, but there has not been a consistent direct relationship.

Accordingly, there is a need to create improved systems, devices, and methods for performing frictional rheological measurements of granular media.

### SUMMARY

The systems, devices, and methods provided for in the present disclosure are directed to rheological measurements of granular media. The measurements can be performed via a material engagement device that includes a plurality of blades associated with a spindle. The spindle is configured to spin about an axis of rotation thereof to promote mixing and measurement of rheological properties using the material engagement device. In some embodiments, an arm can extend between the spindle and the blade to connect the blades to the spindle. The material engagement device can be associated with a rheometer having a shaft and a motor connected to the shaft for rotating the shaft about an axis of rotation of the shaft. In use, the material engagement device can be disposed in a cup having the granular media disposed therein for performing measurements of the granular media. The blades of the material engagement device can rotate within the cup while engaging particles of the powder to promote mixing of the particles.

One exemplary embodiment of a system for measuring rheological properties of a granular material includes a material engagement device that has a spindle having an axis of rotation and one or more blades. The one or more blades include a top sloped surface having an initial positive angle of elevation with respect to a plane perpendicular to the axis of rotation of the spindle, and take a form of an annular section of a helicoid. The top sloped surface is such that a granular material being measured by the system is able to contact the top sloped surface during rotation of the material engagement device.

The system can further include a rheometer configured to couple to the material engagement device that can include a shaft having an axis of rotation, and a motor connected to the shaft for rotating the shaft about the axis of rotation of the shaft. The spindle can be controllably rotated about the axis of rotation to spin the material engagement device relative to the granular material and measure a response therefrom. In some embodiments, the system can simultaneously rotate the spindle and measure the response of the granular material.

In some embodiments, the system can include one or more arms connecting the one or more blades to the spindle. The one or more blades can include one of: two blades, three blades, four blades, five blades, or six blades. A total blade area of the one or more blades as viewed from above the one or more blades can fill outs at least 70% of an area inside of a blade radius of the one or more blades. An initial positive angle of elevation can be approximately in a range of about 10° to about 35°. One or more blades can share a common inner diameter and a common outer diameter when viewed from a plane perpendicular to the spindle. An edge length per blade of the one or more blades can be larger than an outer radius of the one or more blades.

An inertial number of the granular material can be approximately in a range of about 0.1 to about 10. One or more blades can move the granular material along the top sloped surfaces during rotation of the spindle. In some embodiments, the one or more blades can maintain contact with the granular material throughout rotation of the spindle such that particles of the granular material internal to a rotor radius of the one or more blades move vertically as the spindle rotates. A ratio of a distance between a center of the spindle and an exterior edge of the material engagement device to a distance between the center of the spindle and a sidewall can be less than about 0.75.

In some embodiments, the system can further include a cup that has an amount of the granular material disposed therein, and sized to receive at least the one or more blades therein. The one or more blades can rotate relative to the cup to substantially, continuously stir the granular material while performing rheological measurements. The cup can be defined by a sidewall lined with vertical ribs to maintain a no-slip condition along the inside wall. In some embodiments, the system can include an air diffuser installed at the bottom of the cup to provide aeration to granular material in the cup.

One exemplary embodiment of a method for measuring rheological properties of a granular material includes submerging a material engagement device in the granular material, controllably rotating the material engagement device and measuring a response thereof, and determining, based on the response, the rheological properties of the granular material. The material engagement device includes a spindle having an axis of rotation, and one or more blades having a top surface having an initial positive angle of elevation with respect to a plane perpendicular to the axis of rotation of the spindle, the one or more blades taking a form of an annular section of a helicoid.

The method can include continuously stirring the granular material while measuring the response thereof. In some embodiments, the method can further include disposing the granular material in a cup prior to submerging the material engagement device in the granular material, with the cup being sized to receive the one or more blades therein. Rotating the material engagement device and measuring the response can occur substantially simultaneously.

In some embodiments, the method can further include maintaining contact between the one or more blades and the granular material throughout rotation of the material engagement device such that particles of the granular material internal to a rotor radius of the one or more blades moving vertically as the spindle rotates. An initial positive angle of elevation can be in approximately a range of about 10° to about 35°.

### BRIEF DESCRIPTION OF DRAWINGS

This disclosure will be more fully understood from the following detailed description taken in conjunction with the accompanying drawings, in which:

FIG. 1A is a perspective view of one embodiment of an impeller of the present embodiments having two blades and a helix angle of 10°;

FIG. 1B is a perspective view of another embodiment of an impeller of the present embodiments having two blades and a helix angle of 20°;

FIG. 1C is a perspective view of another embodiment of an impeller of the present embodiments having two blades and a helix angle of 35°;

FIG. 1D is a perspective view of another embodiment of an impeller of the present embodiments having three blades and a helix angle of 10°;

FIG. 1E is a perspective view of another embodiment of an impeller of the present embodiments having four blades and a helix angle of 10°;

FIG. 1F is a perspective view of another embodiment of an impeller of the present embodiments having six blades and a helix angle of 10°;

FIG. 1G is a front view of another embodiment of an impeller of the present embodiments;

FIG. 1H is a perspective view of the impeller of FIG. 1A coupled to a rheometer;

FIG. 1I is a perspective view of the rheometer and impeller of FIG. 1H with a cup on the base of rheometer;

FIG. 2A is a photograph of the impeller of FIG. 1A;

FIG. 2B is a photograph of the impeller of FIG. 1B;

FIG. 2C is a photograph of the impeller of FIG. 1C;

FIG. 2D is a photograph of the impeller of FIG. 1D;

FIG. 2E is a photograph of the impeller of FIG. 1E;

FIG. 2F is a photograph of the impeller of FIG. 1F;

FIG. 3A is a top view of the impeller of FIG. 1A;

FIG. 3B is a top view of the impeller of FIG. 1D;

FIG. 3C is a top view of the impeller of FIG. 1E;

FIG. 3D is a top view of the impeller of FIG. 1F;

FIG. 4A is a perspective view of the impeller of FIG. 1A showing the helix angle measured as the angle between the horizontal plane and the helical face of the tool at the outermost radius;

FIG. 4B is a perspective view of the impeller of FIG. 1B showing the helix angle measured as the angle between the horizontal plane and the helical face of the tool at the outermost radius;

FIG. 4C is a perspective view of the impeller of FIG. 1C showing the helix angle measured as the angle between the horizontal plane and the helical face of the tool at the outermost radius;

FIG. 5A is a perspective front view of an exemplary embodiment of a cup clipped onto a base of a rheometer used with the impeller of the present embodiments;

FIG. 5B is perspective top view of the cup of FIG. 5A;

FIG. 6 is a graphical illustration of a minimum fluidization curve showing pressure drop with respect to superficial gas velocity and bed height; and

FIG. 7 is a schematic diagram of one exemplary embodiment of a computer system upon which the control system of the present disclosures can be built.

### DETAILED DESCRIPTION

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

To the extent a term like “fractal” or “fractal-like” is used herein, a person skilled in the art, in view of the present disclosure, will understand that it includes a design that branches for two or more generations in a fractal-type or -like pattern, understanding that fractals can go on infinitely but the instantly disclosed designs can continue in fractal-like patterns for several generations. Additionally, a person skilled in the art will recognize that the term “fractal structure” refers to a construction having one or more core branches extending axially that break into multiple arms, as described and illustrated in greater detail below.

Further, to the extent the term “cruciform” is described in the present disclosure, a person skilled in the art will recognize that it refers to a shape that resembles a wind turbine or a cross, among other shapes recognizable by those skilled in the art in view of the present disclosure. Typical examples of the cruciform shape can have three arms disposed in a triangular arrangement, four arms disposed in a cross arrangement, or six arms that are disposed in a hexagonal arrangement. The arms of the cruciform shape can typically be straight, though, in some embodiments, one of the arms of the cruciform shape can be curved.

Further, to the extent features, sides, or steps are described as being “first” or “second,” such numerical ordering is generally arbitrary, and thus such numbering can be interchangeable. Still further, in the present disclosure, like-numbered components of various embodiments generally have similar features when those components are of a similar nature and/or serve a similar purpose, unless otherwise noted or otherwise understood by a person skilled in the art. Additionally, the present disclosure includes some illustrations and descriptions that include prototypes or bench models. A person skilled in the art will recognize how to rely upon the present disclosure to integrate the techniques, systems, devices, and methods provided for into a product in view of the present disclosures.

The present disclosure generally relates to systems, devices, and methods for rheological measurements of granular media, such as powders. In some embodiments, the material engagement device can include a spindle and a plurality of blades that are configured to be used in conjunction with a rheometer. The blades can have a top surface having an initial angle of elevation with respect to a plane perpendicular to an axis of rotation of the spindle that allows the blades to spin when submerged in the granular media. The material engagement device can be connected to a rheometer and a motor for rotating a shaft of the rheometer about an axis of rotation. The granular media can be disposed within a cup that can allow the blades to be disposed within the granular media while controllably rotating the material engagement device and measuring a response thereof.

Unlike vanes having a fractal-like structure that include one or more arms that branch from a set of one or more of the existing arms and form discrete contact points with yield stress fluids, the devices of the present embodiments maintain contact with a fluid element for multiple time instances to promote thorough mixing of the granular media, and thus have perimeter contacts that extend in a substantially non-vertical direction (i.e., at a slope to the horizontal along the perimeter radius). The design of the present embodiment is such that one fluid element (e.g., a powder particle) maintains contact with a blade for an extended period of time. The branching, tree-like fractal structure can provide a large surface area orthogonal to the spindle axis and large number of perimeter contact points with material to be tested, e.g., a test fluid, while the internal structure remains sparse in terms of displaced volume relative to a bob to limit pre-shearing of a structurally-sensitive material during sample loading. In particular, the series of fractal-like branched structures, which in some instances may be referred to as vane structures, are designed to minimize material displacement when loading the tool into the sample material. This differs from the impellers of the present designs, which are better suited for mixing in some cases, or applying compression to measurement material in some cases, and making rheological measurements of media in which the impeller is disposed. Moreover, because granular media cannot support tensile strains, it cannot be measured by a fractal vane, which relies on the inherent cohesion of the test fluid to form a continuous yield region. In a granular medium, a fractal vane would instead cause fracture of the material and it would then develop an uncontrolled and unpredictable shear band, from which no meaningful measurement could be derived. The impellers of the present designs create a controlled and predictable shearing region in granular media which enables characterization of rheological properties. Some non-limiting examples of terms that can be used to describe the structures of the present embodiments in lieu of and/or in addition to the term “impeller,” and are described as being “impellers” for purposes of brevity throughout the instant application, can include “rotor,” “vane,” or “propeller.”

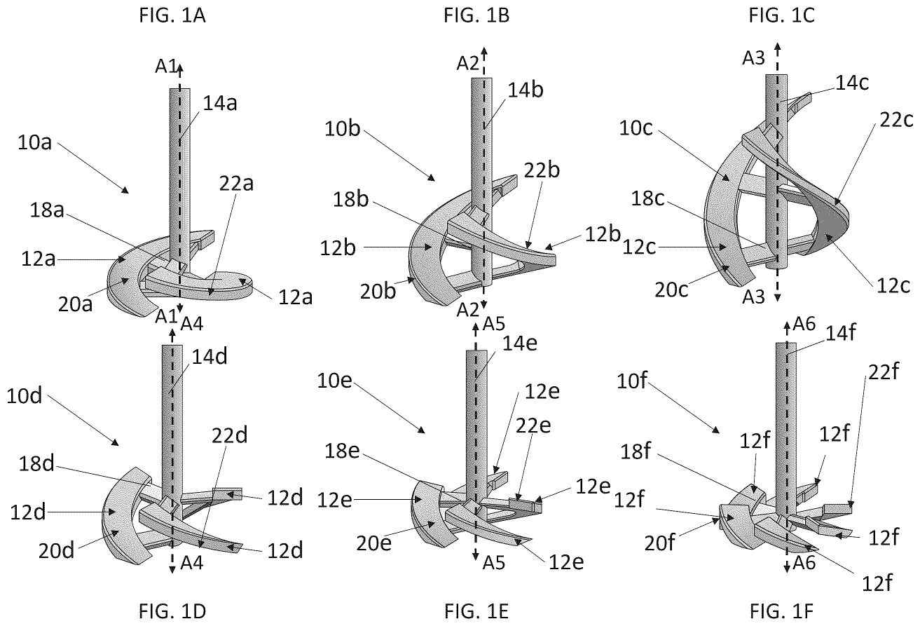

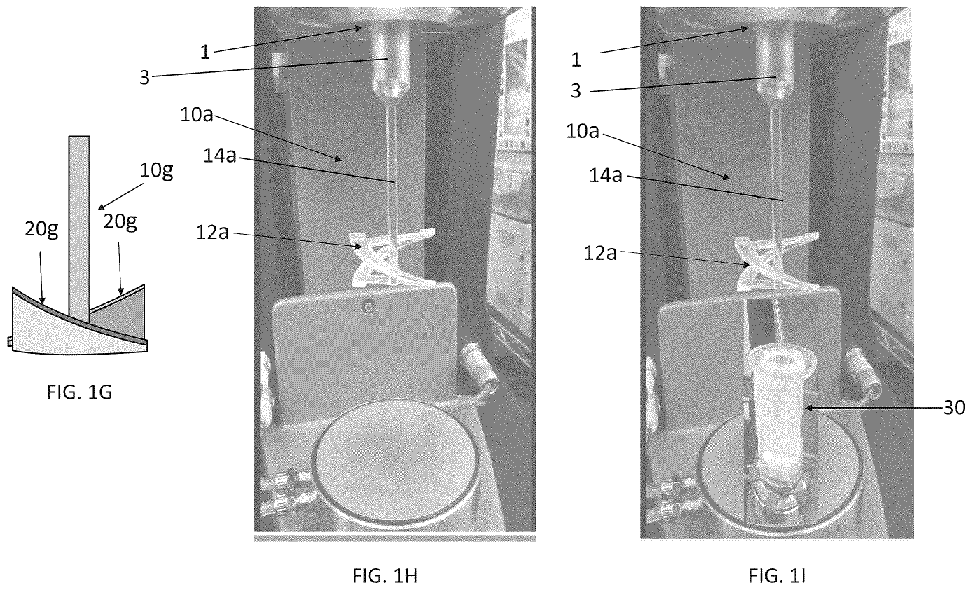

Rheometric tools are typically manufactured via machining of aluminum or of stainless steel. The introduction of the impeller designs of the present embodiments can utilize a manufacturing method that can achieve complex features without excessive cost, and that is capable of creating thin and closely-spaced features such as the profiles shown in the instant figures. Three-dimensional (3D) printing is exceptionally well suited for this task, as its additive nature (which can include, but is not limited to, a layer-by-layer formation) allows complex geometries to be created in three dimensions with, ideally, minimal post-processing or shaping. In particular, designs such as impellers 10a, 10b, 10c, 10e, and 10f illustrated in FIGS. 1A-1F are geometrically complex and can be printed with high quality using a 3D printing technique like stereolithography. Moreover, 3D printing the designs of the present embodiments can allow for production at a low cost and at a rapid rate. A person skilled in the art will recognize that while 3D printing is discussed above, production methods for the impellers of the present embodiments are flexible in that any production that can achieve the desired geometry may be suitable. Moreover, the designs of the tool can permit a variety of methods more traditional than additive manufacturing to be used, such as injection molding, sand (or other) casting, and/or machining.

FIGS. 1A-1F illustrate exemplary embodiments of 3D models of an impeller or material engagement device, devices 10a, 10b, 10c, 10d, 103, and 10f, respectively, that can couple to a rheometer (1, as shown in FIGS. 1H-1I) for measuring rheological properties of a granular material. The impellers 10a-10f of the present embodiments can be used with a stress-controlled or a strain-controlled rheometer. The rheometer can include a shaft 3 having a central axis of rotation that engages the material engagement device 10a of FIG. 1A. As shown, the material engagement device 10a can include a rotor or rotating device having a plurality of inclined blades 12a that are connected, attached, or otherwise associated with a central spindle or shaft 14a. The impeller 10a can be configured to rotate about an axis of rotation A1 of the spindle 14a. Rotation of the spindle 14a can occur in either or both of a clockwise direction and/or a counterclockwise direction. For example, the rheometer 1 can be connected to a motor (not shown) for rotating the shaft of the rheometer 1 about its axis of rotation. FIGS. 1H-1I illustrate the rheometer 1 associated with the material engagement device 10a, though it will be appreciated that any embodiments of the material engagement device 10a-10g can be used. A cup 30 configured to receive the granular media therein is discussed in greater detail below.

In some embodiments, an arm 18a can connect the blades 12a to the spindle 14a. The arm 18a can be separately disposed from either of the blades 12a and/or the spindle 14a. While the discussion of the present embodiments below is performed with respect to the material engagement device 10a of FIG. 1A, it will be appreciated that the features discussed herein can apply to each of the impellers 10b, 10c, 10d, 10e, 10f of FIGS. 1B-1F. As shown, the impellers 10b, 10c, 10d, 10e, 10f of FIGS. 1B-1F can differ from the impeller 10a of FIG. 1A via one or more of an initial angle of elevation, or helix angle α, and/or number of blades, unless otherwise indicated, as discussed in greater detail below. Accordingly, the commonly labeled aspects, which can include, for example spindles 14a, 14b, 14c, 14d, 14e, and 14f, can be similar in form and/or function except as described and/or illustrated herein and/or as otherwise understood by a person skilled in the art in view of the present disclosures and figures. For the sake of brevity, in at least some instances, only one such component (e.g., the spindle 14a) may be described, but a person skilled in the art will understand how related teachings are applicable to the other spindles (e.g., the spindles 14b, 14c, 14d, 14e, and 14f) disclosed herein or otherwise derivable from the present disclosures.

The blades 12a that are associated with a rotor can continuously stir the powder when performing rheological measurements, which can prevent powder compaction while creating a repeatable shear band or shearing zone. Repeatable shear can be optimized by varying a size, shape, angle of the blades 12a, and/or spaces between the blades 12a to create the design that produces the most consistent mixing of the powders in which the impeller 10a is disposed. As shown, the plurality of blades 12a can include a set of helicoid or helical blades that occupy an annulus or an annular region around the central axis A1. For example, the helicoid can occupy an annular region around the central axis A1 of 2π radians, e.g., 360°, or greater. For purposes of the present disclosure, a helicoid blade can be one that has the form of a flattened helix, but for the angular aspects described herein. Some non-limiting examples of a helicoid surface can include a surface formed by a helical curve that has been swept out along its radius and may have a cant (or tilt) away from the horizontal (i.e., up or down) as it proceeds away from the central axis, a spiral surface akin to a screw or bolt thread, a helical surface surrounding a central axis, or a surface forming an inclined path wound around a central axis.

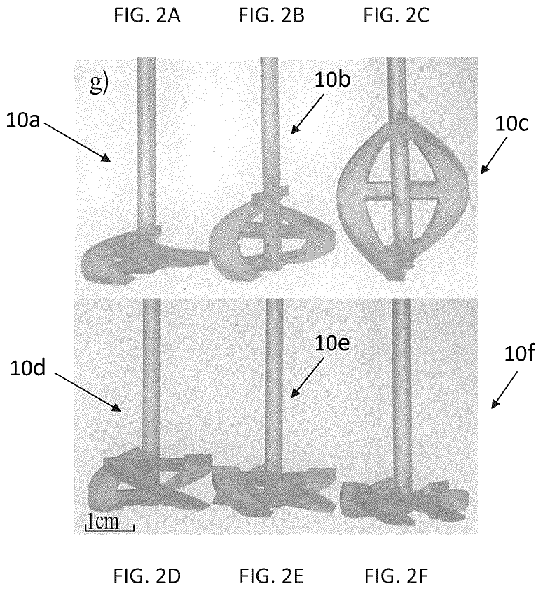

As mentioned above, the blades 12a of the impeller 10a can vary in helix angle α and/or in number of blades. For example, the impellers 10a, 10b, 10c shown in FIGS. 1A-1C can include two blades 12a, 12b, 12c with a helix angle α of (a) approximately 10°, (b) approximately 20°, and (c) approximately 35°, which can correspond to pitches of approximately 19.9 mm, approximately 41.2 mm, and approximately 79.2 mm per revolution. By way of further example, the impellers 10d, 10e, and 10f shown in FIGS. 1D-1F illustrate impeller designs with a constant helix angle α of 10° for a pitch of approximately 41.2 mm, and with three (3), four (4), and six (6) blades, respectively. It will be appreciated that the total blade area should be factored into calculations. For tools with the same helix angle α, the total blade area can be kept constant by reducing the height of the blades as blade count increases. For example, in embodiments of tools with an approximately 20° helix angle α, the tools can have the same total blade area of about 1382.5 mm², though a person skilled in the art will recognize that these values are merely exemplary and provide a convenient way to compare designs. FIGS. 2A-2F illustrate photographs of the impellers 10a, 10b, 10c, 10d, 10e, 10f. In some embodiments, a total blade area of the blades 12a as viewed from above the blades 12a can fill outs at least 70% of an area inside of a blade radius of the one or more blades.

As shown, each blade 12a of the plurality of blades 12 can include a top surface 20a having a helix angle α, with respect to a plane perpendicular to the axis of rotation A1 of the spindle 14a. The angle of elevation can be constant, or can monotonically increase, with an exterior edge or outer edge 22a of the blade 12a having a constant radius from the spindle 14a. In some implementations, the exterior edge 22a can form a helix. The blade 12a can be in the form of an annular section of a helicoid. The blades 12a may incline in opposite directions around the spindle 14a. In some embodiments, the blades 12 share the same inner diameter (ID) and outer diameter (OD), as well as the same projected area when viewed from a plane perpendicular to the spindle 14 independent of the number of blades 12a in the spindle 14a.

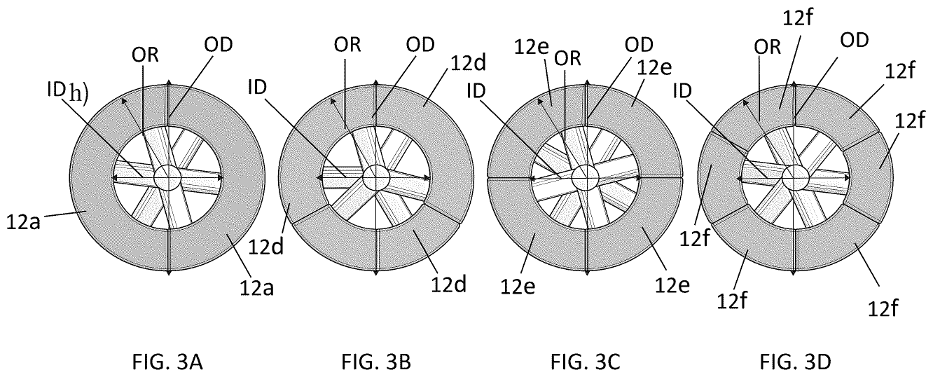

For example, for the exemplary embodiment of the impellers shown in FIGS. 3A-3D, which show two blade, three blade, four blade, and six blade orientations, respectively, the blades 12a, 12d, 12e, and 12f can include an annular region having an inner diameter ID of approximately 26 millimeters (mm) and an outer diameter OD of approximately 36 mm for each impeller design. When viewed from above, all tools can share the same projected blade area of approximately 486.9 mm².

Another example of a helicoid impeller 10g of the present embodiments is shown in FIG. 1G. As shown, the blades 12 may not be thin or uniformly thin in the vertical direction. For example, the impeller 10g can include a shape with a side-view that resembles a doorstop, or a less-shallow helix underneath. In this embodiment, the top surface 20g can perform measurements similar to the embodiments of 20a-20f discussed above.

In some implementations, an end of the blade 12 can be tapered for easier passage through the material, e.g., the powder. In some embodiments, the blades 12a can extend along a constant radius in a helical or inclined path, emerging from the spindle 14a, where the edge length per blade is larger than its outer radius OR. A person skilled in the art will recognize that the size of the particles in the granular media can be much smaller than the size of the blades 12a in the material engagement device 10a.

The impeller 10a of the present embodiments can present several improvements over existing embodiments of vanes having one or more arms that emanate from a single central location in a cruciform shape, or vanes having a fractal-like structure that includes one or more arms that originate at one or more of the existing arms. First, existing vane designs are poor at measuring powder flow properties across wide ranges of inertial numbers. Specifically, existing vane designs are unable to measure powder flow properties at high inertial numbers when the vanes and/or rheometers to which they are coupled move at transition flow speeds and/or high speeds. The ability to measure fast moving or high speed powder flow properties, as well as those in the transition range, allows for use of a single device to capture accurate rheological measurement data where other devices fail. Moreover, using a single device to perform all measurements rather than switching between instruments may allow a user to perform measurement with less overall volume of sample than if the measurements were to be performed in separate instruments, which may be valuable when measuring test fluids, which are not easily or cheaply acquired. Further still, measurements by other methods may be more qualitative, which may make stitching of results of different methods difficult and/or unable to be performed. Use of a single device as per this disclosure can allow characterization of a single material at different speeds (or inertial numbers, which can also vary density, i.e., powder consolidation) so that the same material can be understood in different regimes. On the contrary, existing vanes excel at measuring slow moving flows while struggling with characterizing fast moving flows.

For the purposes of this disclosure, slow moving or low-speed flows can be separated from fast moving or high-speed flows by a threshold value. The threshold value of the present disclosure can include an inertial number of about 0.1, with values below this number being slow moving or low-speed flows. It will be appreciated that the upper limit of 0.1 for inertial number was merely set by the motor of the rheometer, as it cannot spin faster, and it is therefore conceivable that the impellers in the present embodiments could reach a greater upper limit with a more performant motor. Values approximately in a range from above 0.1 to about 100, and/or approximately in a range from above 0.1 to about 10 can be characterized as transition flows, and values higher than that being considered fast moving or high-speed flows. The ability of the impellers of the present embodiments to measure powder flow properties at each of low speeds, high speeds, and transition speeds with accuracy distinguishes over conventional rheometric devices for measuring granular media, such as the Freeman rotor, which are limited to lower speeds due, at least in part, to failing to take accurate measurements above inertial numbers of about five (5). For example, design of the Freeman rotor does not even attempt to measure beyond an inertial number of 0.061. Further limitations of Freeman rotors can include an inferior design to that of the present embodiments with respect to restrictions on surface shape due, at least in part, to the manufacture of Freeman rotors being performed with metals.

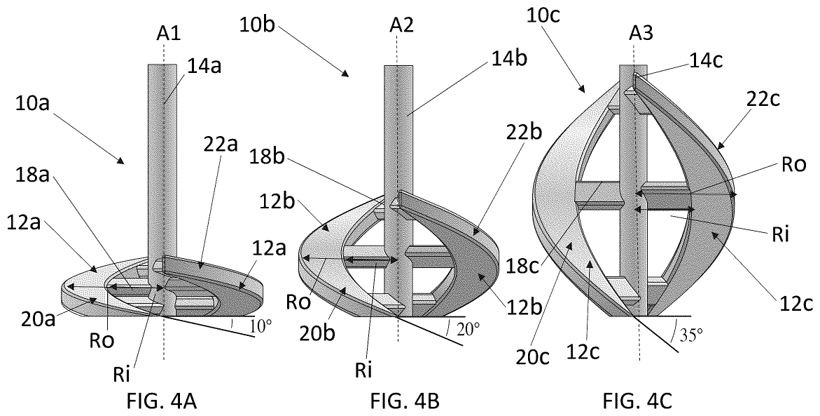

FIGS. 4A-4C illustrate impellers 10 having helix angles α of approximately 10°, approximately 20°, and approximately 35°, respectively. As shown, for the impeller 10a of the present embodiments, the helix angle α can be measured as the angle between the horizontal plane and the surface of the impeller 10a at an outermost radius thereof. As a result, the blades 12a can include a sloped surface that allows the powder to contact and/or move along the surface as the impeller 10a turns. The blades 12a can include a helical structure that, instead of spanning the entirety of the space from the central axis to the outer diameter OD, can be designed to only span an annular region covering a small range of radii relative to the diameter itself.

At least one novel aspect of the present disclosure includes the use of helical blades 12a on the impeller 10a for both mixing and measurement. Conventional rotor designs were not previously used for taking rheological measurements at least due to the vessel in which measurement was to be taken needing to be localized to the tool making such measurements, which leads to bulk motion of the fluid. Localizing the blade area limits the range of helix angles α across the surface of the blade. Localizing the blade area to a limited range of radii can enable the approximation that velocity is uniform across the whole blade, and that paired with a narrow range of helix angles α across the blade 12a can lead to a single shear rate. With the approximation that the powder at the tool surface, e.g., the impeller 10a, can experience a uniform shear rate, the shear stress over the tool surface can be approximated to be uniform.

For example, tools with 10° helix angles α at their outermost radius Rₒ, as shown in FIG. 4A, can have helix angles α at their inner radius Rᵢ of αᵢₙₙₑᵣ=13.7°. Further, tools with 20° helix angles α at their outermost radius Rₒ can have αᵢₙₙₑᵣ=26.7° and tools with 35° helix angles α at their outermost radius Rₒ can have αᵢₙₙₑᵣ=44.1°. In each case, this is approximately a 30% increase from the outer helix angle α to the inner helix angle αᵢₙₙₑᵣ, which can set by the ratio between the outer radius Rₒ and the inner radius Rᵢ as seen in Eq. 1, reproduced below:

$${α}_{inner} = {tan}^{- 1} ( \frac{{R}_{o}}{{R}_{t}} tan ( {α}_{outer} ) ) \qquad ( 1 )$$

Because the tools have a helix angle that varies with radius, the outer helix angle α discussed herein refers to the outer helix angle, henceforth just called the helix angle of the tool.

The 30% increase from the outer helix angle to the inner helix angle can lead to a shear rate distribution that is not perfectly uniform. As a result, the specific shape of the blade 12a can be further tailored to generate a constant shear rate across the radius.

In some embodiments, the tools can be designed in SolidWorks (Dassault Systèmes) and printed using a Form 3L SLA 3D printer (Formlabs, USA) using Clear V4 resin (Formlabs, USA). The tools can be printed with a 50 μm layer height vertically upright with supports attached to the helical blades. In some embodiments, the tools can be printed with support structures and covered in residual uncured resin after printing. After being removed from the bed, the tools can be washed in isopropanol to remove residual resin and the support structures were removed manually.

In some embodiments, the material engagement device 10a can predominantly trap rather than mix powder or fluid internal to the blade annulus. The blades 12a can be closely packed to primarily generate a shear field on and near the inclined surface. In such embodiments, the incline of the blades 12a can apply a more local compression or dilation to the powder, and can perform more like an elongated series of wedges. In some embodiments, the material engagement device 10a can include elongating wedges along the helix path. Moreover, the incline of the blades 12a allow the blades to push powder along each blade 12a during rotation of the spindle 14a, which differs from that conventional fractal-like vanes having a plurality of discrete contact points, e.g., long vertically but short horizontally, in the direction of movement when rotating the spindle. In the impeller 10a of the present embodiments, the inclined ramps of the helices of the blades 12a can maintain contact throughout rotation of the spindle 14a such that a single particle of powder can contact different parts of the same surface of the same blade 12a at multiple successive time instances and/or the same part of the blade 12a at multiple successive time instances. For example, a particle may travel along the length or width of the same blade 12a, while remaining in contact with the same blade 12a over multiple time instances, the total duration of which may vary with the blade length, an arc angle length of the blade 12a, and/or the rotation rate. That is, individual particles of powder can change as a function of position on the central axis A1 along the circumference of the outer diameter OD of the impeller 10a. It will be appreciated that in some embodiments, the blade 12a can include a thin layer of powder stuck to surfaces thereof due to the surfaces of the blade 12a, e.g., the top surface 20a, being sticky and/or wet after printing. The individual particles of powder stuck to the surface can move with the surfaces of the blades 12a and can be considered part of, e.g., integral to, the surface of the blade 12a for the purposes of this disclosure. In such embodiments, the individual particles of powder for which rheological data is being measured can therefore be those particles that are internal to a rotor radius that are able to move vertically as the spindle 14a rotates, and may exclude those that are considered part of the surface of the blade 12a.

The above-described features of the blades 12a differ from that of fractal-like vanes that have a large number of contact points such that powder particles cycle between multiple contact points over successive time instances. The ability of the blades 12a to remain in contact with a single particle over an extended period of time, e.g., multiple successive time instances can significantly improve mixing performance as the spindle 14a spins, yielding more accurate and precise rheological measurements. Moreover, individual particles can be convected in vertical, radial, and circular motions throughout the domain by the blades 12a of the present embodiments, and different regions of the bulk medium can be continuously deformed, thus homogenizing the material and ensuring that no region becomes compacted or isolated from the rest of the domain. This is distinct from the fractal vane which simply carries particles in circular motions and does not actively homogenize the test fluid during deformation.

A time instance that a particle may travel along the length or width of the same blade 12a, while remaining in contact with the same blade 12a can range approximately from about 0.0035 seconds to at least about 314.16 seconds. These values were obtained following measurements of angular rates of rotation that ranged from about 0.01 rad/s to about 300 rad/s, with the blades sweeping out to π radians and as little as π/3 radians. A smaller minimum contact time may be used in order to perform measurements at larger inertial numbers, and this reduced contact time is not expected to negatively impact the measurement capabilities of the device.

The spindle 14a can be controllably rotated to spin the blades 12a and measure a response therefrom. Rheological properties of the granular material can be determined based on the response. A person skilled in the art will recognize that rheological measurements are taken between two surfaces, e.g., a spinning rotor such as the impeller 10a and a stationary surface. In some embodiments, the impeller 10a can be used with a cup 30 to improve convenience and versatility of the entire testing procedure.

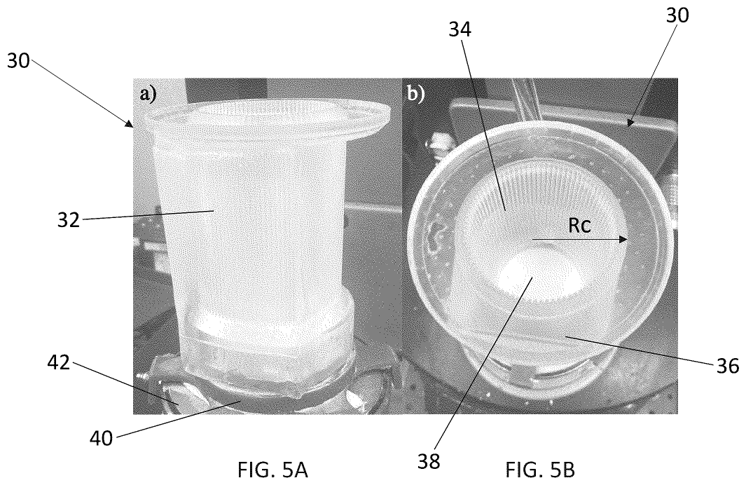

FIGS. 5A-5B illustrate an example embodiment of a cup 30 that can be used with the impellers 10a, 10b, 10c, 10d, 10e, and/or 10f of the present embodiments. The cup 30 can have any shape, e.g., cylindrical, pyramidal, cubic, and so forth. The cup 30 can be defined by a sidewall 32 having a textured surface 34 on an internal wall thereof. For example, the inside wall of the cup 30 can be lined with 1 mm wide vertical ribs or cannulated ribs to maintain the no-slip condition of the powder bed at the wall.

The cup 30 can have an internal aeration system to help fluidize the powder during measurements. As shown, the cup 30 can include a glass slide 36 applied to one flat face on the front to facilitate visual inspection of flow at the inside wall. As seen from the top, an air diffuser 38 (e.g., 2-inch diameter, Pawfly) can be installed at the bottom of the cup 30 to enable aeration and fluidization by serving as an inlet for gas, which then travels through the powder. The air diffuser 38 can distribute incoming airflow across its top surface to provide even aeration to the powder bed above. In some embodiments, a fine nylon mesh can cover its surface to prevent powder from obstructing the pores of an air stone that can be disposed at the bottom of the cup 30. The diffuser 38 can be covered with a fine nylon mesh (e.g., 371 mesh size, 9318T25, McMaster) to prevent powder particles from resting on the air diffuser and settling down into the small pores that enable aeration.

In some embodiments, the cup 30 can be 3D printed to hold the sample material being tested. The cup 30 can be include a base 40 that can be threaded, glued, or otherwise associated in a variety of ways with the cup 30 that will be recognized by a person having ordinary skill in the art. By way of non-limiting example, the base 40 can fasten onto a standard rheometer base 42, e.g., a Peltier plate, that is a standard lower fixture on the Discovery Hybrid Rheometer (DHR) or the ARES-G2 Rheometer (AR-G2), both from TA Instruments (New Castle, DE). The Peltier plate can hold it, for instance, by an interference fit of six protruding arms or by using the arms as guides and using double-sided tape under the base for a more adjustable hold, among other techniques. A well-calibrated Peltier plate is generally orthogonal to the axis of the rotating spindle but is not necessarily concentric with it. The yielded area can be set entirely by the location of the vane perimeter and can extend radially outwards. For measurements of yield stress fluids with a wide-gap geometry, precise concentricity of the cup may not be critical. For example, the impeller 10a of the present embodiments can be smaller than an opening of the cup to leave a gap between the blades 12a and the sidewall 132, which is distinct from conventional rheological system that have no such gap between the instrument and the inner sidewall.

The cup 30 can be detachable from the base 40, to be used, for example, as a cylinder without a bottom to facilitate loading and/or cleaning thicker or gelling samples. The base 40 can be designed to facilitate attachment of different cups thereto. For example, the cup 30 can unscrew from the base 40, making it straightforward to access material in the cup for filling and cleaning. As an added benefit, this means that a single base can be used interchangeably with several 3D printed cups that differ in height and diameter, or that are pre-filled with different fluid samples, as long as they use the same (custom) 3D-printed mating thread. This enables multiple samples to be pre-filled and conditioned with a controlled waiting time and thermal history, if desired, then mounted directly onto the rheometer just prior to testing. In other embodiments, the impeller 10a can be used directly in a large vat of fluid or in a cup of various shapes. Additionally and/or alternatively, in some embodiments, the rotational rheometer can include a concentric cylinder setup where the material engagement device 10a can serve as an inner “cylinder,” and the cup 30 can serve as an outer cylinder. In use, the material engagement device 10a can be completely submerged in the powder and then rotated within the powder while submerged to perform rheological measurement of granular media.

To measure rheological properties of powders, it can be desirable to avoid significant shear stress between the blades 12a and the walls 32 of the cup 30. In the embodiments shown herein, the material engagement device 10a can be designed to function with a large gap between the outer edge 22a of the blades 12a and the internal walls 34 of the cup 30. For example, the ratio of the outer radius Rₒ of the helix to a radius Rc of the cup 30 can be preferably less than about 0.75. That is, a ratio of a distance between a center of the spindle 14a and an exterior edge of the material engagement device 10a to a distance between the center of the spindle 14a and the wall 34 can be less than about 0.75. The height ratio can be similarly smaller than about 1, and may have a value less than about 0.5, which can allow the material engagement device 20 to perform as if it is in an “infinite” body of powder.

In some embodiments, the relative geometries of the material engagement device 10 and the cup 30 can be such that there is a large outer gap (outer radius of helix to radius of cup 30) and a small inner gap (inner radius of helix annulus to center of cup 30). In some implementations, the inner gap also may be entirely absent. Further, the outer gap dimension can, in some embodiments, be compared to the width of the annulus of the helix. For example, in some embodiments, the cup 30 can have an inner diameter of about 50 mm, which can allow for about 7 mm of clearance between the tools, e.g., the impeller 10, and the wall 32 of the cup 30. A person skilled in the art will appreciate these values are only provided as an example, and are by no means limiting.

Aeration and fluidization can be used in the cup 30 as a conditioning step to maintain bed uniformity, prevent powder agglomeration and compaction, and/or modulate powder pressure. Air volumetric flow rate can be measured using a variable area flowmeter (about 100 mL/min air to about 1000 mL/min air, CNBTR), and superficial gas velocity u can be determined using Eq. 2, where Q is the volumetric flow rate, and D is the internal diameter of the cup:

$$u = \frac{Q}{\frac{π}{4} {D}^{2}} \qquad ( 2 )$$

In order to appropriately measure the powder friction number μ and the inertial number I, the pressure in the powder at the depth of the tool should be known. In some embodiments, the air pressure drop can be measured using an LPS22 pressure sensor (Adafruit, USA), which measures absolute air pressure with an uncertainty of approximately ±100 Pa and relative air pressure with an uncertainty of approximately ±10 Pa. Data collection can be performed by an Arduino Nano microcontroller. The sensor can be submerged in the powder bed to a depth of about 50 mm, which is a depth where the helical annular tools can be operated, and can measure the air pressure drop from that location to the ambient for several superficial gas velocities. As superficial gas velocity increases, the air pressure drop across the bed can increase up to a maximum necessary to support the weight of the entire powder bed.

With the powder bed in the cup 30 and seated on the rheometer, the powder bed can be fluidized to the point of channeling to dispel any packing or residual stresses the bed may contain from prior experiments and/or from initial loading. After channeling the powder bed, the cup 30 can be tapped on the side, for example about 100 times, to settle the powder bed and remove regions of low volume fraction, thus making the powder bed more uniform throughout. After the powder has been settled, the powder can then be aerated or fluidized to the target superficial gas velocity. If no aeration is involved in a test, this step can be omitted.

In aeration and fluidization testing, the air can be supplied to the cup 30 by a pressure-controlled air supply, and the volumetric flowrate was measured with a variable-area flowmeter. Because the system can be pressure controlled instead of flowrate controlled, there may be freedom to deviate from the flowrate originally set. This can allow for flowrate to either increase as a path of lower resistance forms, or for flowrate to decrease as powder compacts and obstructs flow paths.

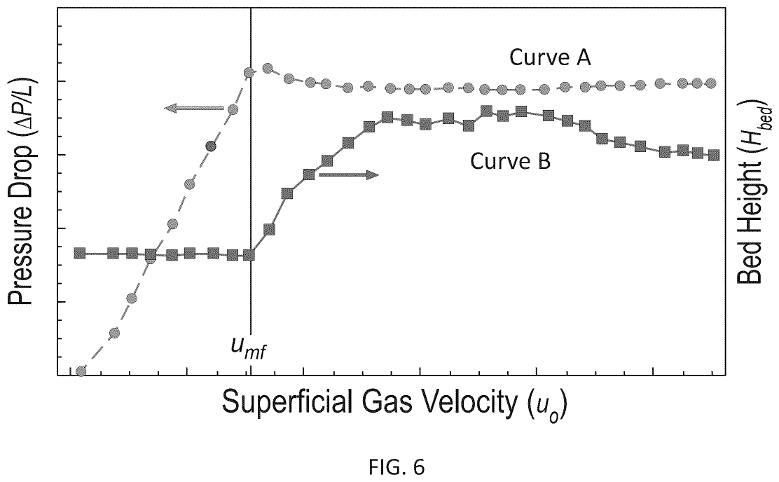

FIG. 6 illustrates the relationship between superficial gas velocity in an aerated or fluidized bed and the pressure drop across the bed, as well as the height of the bed in greater detail. As shown, the typical minimum fluidization curve can illustrate that the pressure drop (curve A) can increase with superficial gas velocity until the point at which the gas velocity is high enough that the drag force is equal to the weight of the particle. At this point, which is the minimum fluidization velocity, the bed may become fluidized, and the bed height (curve B) can increase. As the air passing through the powder bed imposes drag forces on the powder particles, it can experience a drop in air pressure. Further, as the superficial gas velocity increases, this drop in air pressure may also increase. This pressure drop can increases until the superficial gas velocity reaches the minimum fluidization velocity μ_{mf}, at which point the weight of the powder bed can be fully supported by the aerating fluid. At this point, the powder bed may be considered fluidized and can begin to expand upward, which can decrease the volume fraction. After the onset of fluidization, channeling may occur, where a channel forms of fast-moving bubbles that bypass most of the bed. When channeling occurs, the superficial gas velocity and powder volume fraction become very non-uniform throughout the powder bed.

Computer programs can be used to compute values of properties in response to measurements from equipment. Torque and axial force, shear rate, and shear stress can be computed based on their correlation to geometry and rotation rate. For example, in use, the impeller 10a can be inserted into the cup 30 having a yield stress material, e.g., shampoo, conditioner, hair gel, lotions, toothpaste, condiments like ketchup and mayonnaise, and/or concrete, therein. Following insertion, the impeller 10a can be rotated, which causes the shearing of the material to exert a torque on the impeller 10a. In some embodiments, the devices of the present embodiments can interface with a computer storage device having computer program instructions encoded thereon which, when processed by a computer, instruct the computer to control rotation of a rheometer using the material engagement device submerged in the granular material, measure response through the rheometer, and/or to compute, based on the measured response, the rheological properties of the material.

One or more computers can be used to implement such a computational pipeline, using one or more general-purpose computers, such as client devices including mobile devices and client computers, one or more server computers, or one or more database computers, or combinations of any two or more of these, which can be programmed to implement the functionality such as described in the example implementations.

Any of the foregoing aspects may be embodied as a computer system, as any individual component of such a computer system, as a process performed by such a computer system or any individual component of such a computer system, or as an article of manufacture including computer storage in which computer program code is stored and which, when processed by the processing system(s) of one or more computers, configures the processing system(s) of the one or more computers to provide such a computer system or individual component of such a computer system.

Each component (which also may be called a “module” or “engine” or “computational model” or the like), of a computer system such as described herein, and which operates on one or more computers, can be implemented as computer program code processed by the processing system(s) of one or more computers. Computer program code includes computer-executable instructions and/or computer-interpreted instructions, such as program modules, which instructions are processed by a processing system of a computer. Typically, such instructions define routines, programs, objects, components, data structures, and so on, that, when processed by a processing system, instruct the processing system to perform operations on data or configure the processor or computer to implement various components or data structures in computer storage. A data structure is defined in a computer program and specifies how data is organized in computer storage, such as in a memory device or a storage device, so that the data can accessed, manipulated, and stored by a processing system of a computer.

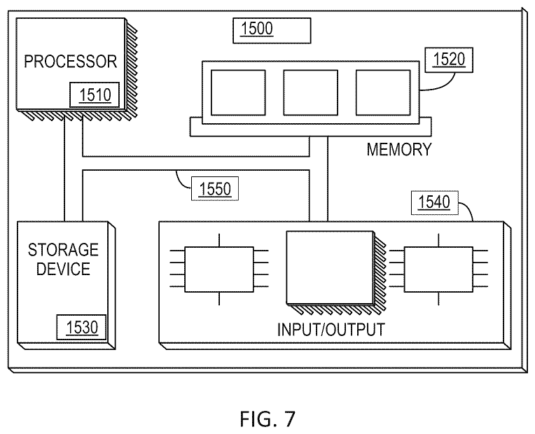

In some embodiments, the present embodiments can be coupled and/or otherwise associated with a controller configured to control the rheometer and/or the material engagement device 10a. FIG. 7 is a block diagram of one exemplary embodiment of a computer system 1500 upon which the controller or control system of the present disclosures can be built, performed, trained, etc. For example, any devices or systems can be examples of the system 1500 described herein. The system 1500 can include a processor 1510, a memory 1520, a storage device 1530, and an input/output device 1540. Each of the components 1510, 1520, 1530, and 1540 can be interconnected, for example, using a system bus 1550. The processor 1510 can be capable of processing instructions for execution within the system 1500. The processor 1510 can be a single-threaded processor, a multi-threaded processor, or similar device. The processor 1510 can be capable of processing instructions stored in the memory 1520 or on the storage device 1530. The processor 1510 may execute operations such as, by way of non-limiting examples, instruct the computer to control rotation of a rheometer using the material engagement device submerged in the granular material, measure response through the rheometer, and/or to compute, based on the measured response, the rheological properties of the material. The controller 1500 can optimize operation in response to varying powder properties, fluid flow rates, and the like. The controller 1500 may further embed machine-learning techniques, artificial intelligence, and/or digital twinning that can aid in improving performance.

The memory 1520 can store information within the system 1500. In some implementations, the memory 1520 can be a computer-readable medium. The memory 1520 can, for example, be a volatile memory unit or a non-volatile memory unit. In some implementations, the memory 1520 can store information related to powder properties, impeller designs, and so forth.

The storage device 1530 can be capable of providing mass storage for the system 1500. In some implementations, the storage device 1530 can be a non-transitory computer-readable medium. The storage device 1530 can include, for example, a hard disk device, an optical disk device, a solid-date drive, a flash drive, magnetic tape, and/or some other large capacity storage device. The storage device 1530 may alternatively be a cloud storage device, e.g., a logical storage device including multiple physical storage devices distributed on a network and accessed using a network. In some implementations, the information stored on the memory 1520 can also or instead be stored on the storage device 1530.

The input/output device 1540 can provide input/output operations for the system 1500. In some implementations, the input/output device 1540 can include one or more of network interface devices (e.g., an Ethernet card or an InfiniBand interconnect), a serial communication device (e.g., an RS-232 10 port), and/or a wireless interface device (e.g., a short-range wireless communication device, an 802.7 card, a 3G wireless modem, a 4G wireless modem, a 5G wireless modem). In some implementations, the input/output device 1540 can include driver devices configured to receive input data and send output data to other input/output devices, e.g., a keyboard, a printer, and/or display devices. In some implementations, mobile computing devices, mobile communication devices, and other devices can be used.

In some implementations, the system 1500 can be a microcontroller. A microcontroller is a device that contains multiple elements of a computer system in a single electronics package. For example, the single electronics package could contain the processor 1510, the memory 1520, the storage device 1530, and/or input/output devices 1540.

Although an example processing system has been described above, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a system for rheological measurements of granular media. The computer readable medium can be a machine-readable storage device, a machine-readable storage substrate, a memory device, a composition of matter effecting a machine-readable propagated signal, or a combination of one or more of them.

Various embodiments of the present disclosure may be implemented at least in part in any conventional computer programming language. For example, some embodiments may be implemented in a procedural programming language (e.g., “C” or ForTran95), in an object-oriented programming language (e.g., “C++”), and/or other programming languages (e.g. Java, JavaScript, PHP, Python, and/or SQL). Other embodiments may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including, by way of non-limiting examples, a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical, or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the present disclosure may be implemented as a combination of both software (e.g., a computer program product) and hardware. Still other embodiments of the present disclosure are implemented as entirely hardware, or entirely software.

Examples of the above-described embodiments can include the following:
1. A system for measuring rheological properties of a granular material, comprising:
   a material engagement device that includes:
      a spindle having an axis of rotation; and
      one or more blades having a top sloped surface having an initial positive angle of elevation with respect to a plane perpendicular to the axis of rotation of the spindle, the one or more blades taking a form of an annular section of a helicoid, and the top sloped surface being configured such that a granular material being measured by the system is able to contact the top sloped surface during rotation of the material engagement device.
2. The system of example 1, further comprising a rheometer configured to couple to the material engagement device, the rheometer comprising:
   a shaft having an axis of rotation; and
   a motor connected to the shaft for rotating the shaft about the axis of rotation of the shaft.
3. The system of example 1 or example 2, wherein the spindle is configured to be controllably rotated about the axis of rotation to spin the material engagement device relative to the granular material and measure a response therefrom.
4. The system of example 3, wherein the system is further configured to simultaneously rotate the spindle and measure the response of the granular material.
5. The system of any of example 1 to example 4, further comprising one or more arms connecting the one or more blades to the spindle.
6. The system of any of example 1 to example 5, wherein the one or more blades comprises one of: two blades, three blades, four blades, five blades, or six blades.
7. The system of example 6, wherein a total blade area of the one or more blades as viewed from above the one or more blades fills outs at least 70% of an area inside of a blade radius of the one or more blades.
8. The system of any of example 1 to example 7, wherein the initial positive angle of elevation is approximately in a range of about 10° to about 35°.
9. The system of any of example 1 to example 8, wherein the one or more blades share a common inner diameter and a common outer diameter when viewed from a plane perpendicular to the spindle.
10. The system of any of example 1 to example 9, wherein an edge length per blade of the one or more blades is larger than an outer radius of the one or more blades.
11. The system of any of example 1 to example 10, wherein an inertial number of the granular material is approximately in a range of about 0.1 to about 10.
12. The system of any of example 1 to example 11, wherein the one or more blades is configured to move the granular material along the top sloped surfaces during rotation of the spindle.
13. The system of example 12, wherein the one or more blades are configured to maintain contact with the granular material throughout rotation of the spindle such that particles of the granular material internal to a rotor radius of the one or more blades move vertically as the spindle rotates.
14. The system of any of example 1 to example 13, further comprising a cup configured to have an amount of the granular material disposed therein, the cup being sized to receive at least the one or more blades therein.
15. The system of example 14, wherein the one or more blades are configured to rotate relative to the cup to substantially, continuously stir the granular material while performing rheological measurements.
16. The system of example Error! Reference source not found, or example 15, further comprising an air diffuser installed at the bottom of the cup to provide aeration to granular material in the cup.
17. The system of any of example 14 to example 17, wherein the cup is defined by a sidewall lined with vertical ribs to maintain a no-slip condition along the inside wall.
18. The system of any of example 1 to example 17, wherein a ratio of a distance between a center of the spindle and an exterior edge of the material engagement device to a distance between the center of the spindle and a sidewall is less than about 0.75.
19. A method for measuring rheological properties of a granular material, comprising: submerging a material engagement device in the granular material, wherein the material engagement device includes a spindle having an axis of rotation, and one or more blades having a top surface having an initial positive angle of elevation with respect to a plane perpendicular to the axis of rotation of the spindle, the one or more blades taking a form of an annular section of a helicoid;
   controllably rotating the material engagement device and measuring a response thereof; and
   determining, based on the response, the rheological properties of the granular material.
20. The method of example 19, further comprising continuously stirring the granular material while measuring the response thereof.
21. The method of example 19 or example 20, further comprising disposing the granular material in a cup prior to submerging the material engagement device in the granular material, the cup being sized to receive the one or more blades therein.
22. The method of any of example 19 to example 21, wherein rotating the material engagement device and measuring the response occurs substantially simultaneously.
23. The method of any of example 19 to example 22, further comprising maintaining contact between the one or more blades and the granular material throughout rotation of the material engagement device such that particles of the granular material internal to a rotor radius of the one or more blades moving vertically as the spindle rotates.
24. The method of any of example 19 to example 23, wherein the initial positive angle of elevation is in approximately a range of about 10° to about 35°.

One skilled in the art will appreciate further features and advantages of the disclosures based on the provided for descriptions and embodiments. Accordingly, the inventions are not to be limited by what has been particularly shown and described. All publications and references cited herein are expressly incorporated herein by reference in their entirety.

Some non-limiting claims are provided below.

We claim:

1. A system for measuring rheological properties of a granular material, comprising:
a material engagement device that includes:
a spindle having an axis of rotation; and
one or more blades having a top sloped surface having an initial positive angle of elevation with respect to a plane perpendicular to the axis of rotation of the spindle, the one or more blades taking a form of an annular section of a helicoid, and the top sloped surface being configured such that a granular material being measured by the system is able to contact the top sloped surface during rotation of the material engagement device.

2. The system of claim 1, further comprising a rheometer configured to couple to the material engagement device, the rheometer comprising:
a shaft having an axis of rotation; and
a motor connected to the shaft for rotating the shaft about the axis of rotation of the shaft.

3. The system of claim 1, wherein the spindle is configured to be controllably rotated about the axis of rotation to spin the material engagement device relative to the granular material and measure a response therefrom.

4. The system of claim 3, wherein the system is further configured to simultaneously rotate the spindle and measure the response of the granular material.

5. The system of claim 1, further comprising one or more arms connecting the one or more blades to the spindle.

6. The system of claim 1, wherein the one or more blades comprises one of: two blades, three blades, four blades, five blades, or six blades.

7. The system of claim 6, wherein a total blade area of the one or more blades as viewed from above the one or more blades fills outs at least 70% of an area inside of a blade radius of the one or more blades.

8. The system of claim 1, wherein the initial positive angle of elevation is approximately in a range of about 10° to about 35°.

9. The system of claim 1, wherein the one or more blades share a common inner diameter and a common outer diameter when viewed from a plane perpendicular to the spindle.

10. The system of claim 1, wherein an edge length per blade of the one or more blades is larger than an outer radius of the one or more blades.

11. The system of claim 1, wherein an inertial number of the granular material is approximately in a range of about 0.1 to about 10.

12. The system of claim 1, wherein the one or more blades is configured to move the granular material along the top sloped surfaces during rotation of the spindle.

13. The system of claim 12, wherein the one or more blades are configured to maintain contact with the granular material throughout rotation of the spindle such that particles of the granular material internal to a rotor radius of the one or more blades move vertically as the spindle rotates.

14. The system of claim 1, wherein a ratio of a distance between a center of the spindle and an exterior edge of the material engagement device to a distance between the center of the spindle and a sidewall is less than about 0.75.

15. A method for measuring rheological properties of a granular material, comprising:
submerging a material engagement device in the granular material, wherein the material engagement device includes a spindle having an axis of rotation, and one or more blades having a top surface having an initial positive angle of elevation with respect to a plane perpendicular to the axis of rotation of the spindle, the one or more blades taking a form of an annular section of a helicoid;
controllably rotating the material engagement device and measuring a response thereof; and
determining, based on the response, the rheological properties of the granular material.

16. The method of claim 15, further comprising continuously stirring the granular material while measuring the response thereof.

17. The method of claim 15, further comprising disposing the granular material in a cup prior to submerging the material engagement device in the granular material, the cup being sized to receive the one or more blades therein.

18. The method of claim 15, wherein rotating the material engagement device and measuring the response occurs substantially simultaneously.

19. The method of claim 15, further comprising maintaining contact between the one or more blades and the granular material throughout rotation of the material engagement device such that particles of the granular material internal to a rotor radius of the one or more blades moving vertically as the spindle rotates.

20. The method of claim 15, wherein the initial positive angle of elevation is in approximately a range of about 10° to about 35°.
